(19) United States
(12) Patent Application Publication
(10) Pub. No.: US 2003/0219508 A1
(43) Pub. Date: Nov. 27, 2003

(54) Apparatus for compensation of tilting in the mold closing units of injection molding machines

(75) Inventors: Wolfgang Hechtl, Munchen (DE); Heinz Krallmann, Hiddenhausen (DE); Stephan Fischer, Hiddenhausen (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/414,819

(22) Filed: Apr. 16, 2003

Related U.S. Application Data
(63) Continuation of application No. PCT/EP01/11919, filed on Oct. 16, 2001.

(30) Foreign Application Priority Data
Oct. 19, 2000 (DE) 100 51 837.0

(51) Int. Cl. B29C 45/66

(52) U.S. Cl. 425/588

(57) ABSTRACT

An apparatus for compensation of tilting in closing units of injection molding machines, includes a base plate securable to one of the mold mounting plates, and a mold carrier plate for receiving the half-mold associated to this mold mounting plate, with the mold carrier plate being tiltable in relation to the base plate. The base plate is connected to the mold carrier plate via a cup bearing and prestressed relative to the mold carrier plate by a prestressing means such that a gap is established between the base plate and the mold carrier plate outside the cup bearing> The prestressing means are arranged at such a slant to the symmetry axis of the closing unit that the contact surfaces acted upon by the prestressing means and the bearing surface of the cup bearing lie substantially on parallel calottes, preferably on the same calotte.

### CROSS-REFERENCES TO RELATED APPLICATIONS

This application is a continuation of prior filed copending PCT International application no. PCT/EP01/11919, filed Oct. 16, 2001, which designated the United States and on which priority is claimed under 35 U.S.C. §120, the disclosure of which is hereby incorporated by reference.

This application claims the priority of German Patent Application, Serial No. 100 51 837.0, filed Oct. 19, 2000, pursuant to 35 U.S.C. 119(a)-(d), the disclosure of which is incorporated herein by reference.

### BACKGROUND OF THE INVENTION

The present invention relates to an apparatus for compensation of tilting in the mold closing units of injection molding machines

The apparatus known from German Pat. No. DE 20 28 009 A includes two flexible plates, which are provided between a half-mold and a swivel arm serving as mold mounting plate and which are sealingly connected to one another at their edges, with the enclosed cavity acted upon by a pressure medium via a suitable connection. Both flexible plates are supported on their outer surface by two fixed-plates, of which one rests upon a half-mold bearing, which carries the half-mold, and the other rests upon a carrier, which is mounted on the swivel arm. This carrier includes webs which are directed outwards in vertical direction and which are engaged by matching webs pointing inwardly in vertical direction from the half-mold bearing. As pressure medium is admitted into the cavity, the vertical webs of the half-mold bearing are firmly pressed against the opposing webs of the carrier on the side of the swivel arm. Possible parallel shifts between the cooperating half-molds are compensated directly by the plates through displacement of the pressure medium. Suitable spacer plates between the inwardly directed vertical webs of the half-mold bearing and the confronting outer surface of the carrier enable a precise flush alignment in axial direction of the half-mold, secured on the swivel arm, relative to the other half-mold. This compensating apparatus is disadvantageous because of the complexity of sealing the cavity, on one hand, and the requirement to provide a connection port for supply of the pressure medium from a storage reservoir, on the other hand.

To avoid the problems accompanying a liquid pressure medium, it is further known (DE 196 09 568 C2) to place under pressure a plurality of steel balls in two or more layers within a compartment which is closed by means of a pressure compensating plate, whereby the pressure compensating plate and the compartment are each supported by adjoining, pressure-loaded machine parts, such that the pressure compensating plate so adjusts, when the machine parts are subjected to a pressure, that the same specific pressure is realized across the entire surface. To allow easy rearrangement of the balls in the compartment and good adjustment thereof to volumetric changes as a result of tilting, dry graphite is added. This compensating apparatus is disadvantageous because the balls have generally spot contact, i.e. only a very slight surface pressure is provided. Thus, the balls require a substantially greater surface to be acted upon as would be necessary for the surface pressure. When the clamping force builds up, the balls are pushed into one another and additionally pressed into the surface of the compartment. Moreover, as the tool is opened and closed, there is a pump effect as a consequence of the rearrangement of the balls, resulting in an increased wear of the balls. Therefore, the installation height for the mold cannot be precisely determined. Overall, in view of these deficiencies, the precision of compensating the angle offset as well as the maintenance of this precision during operation are adversely affected. This apparatus is generally unsuitable for injection-compression molding as the compression stroke cannot be accurately set.

It is further known (DE 195 11 808 C2), to compensate in a rodless mold closing device during the application of the clamping force deformations of the C-shaped machine frame on the side of the moving mold mounting plate by connecting the piston rod of a working cylinder with the moving mold mounting plate via a joint which is configured as cup bearing. The piston rod of the working cylinder has one end formed with an annular groove which is adjoined at the end face by a spherical joint head. A matching cup-shaped recess is formed in the moving tool mounting plate. The spherical joint head of the piston rod of the working cylinder bears upon the cup-shaped recess, and is rotatably movable therein and is detachably connected by a split ring flange and a screw connection with the moving mold mounting plate. In this manner, the moving mold mounting plate can tilt and adjust relative to the piston rod and thus relative to the machine frame such that both mold mounting plates and the attached half-molds maintain their parallel alignment despite the deformation of the machine frame. Maintenance of a tilted position of the joint head in the joint cup is not provided. This compensating apparatus is disadvantageous because the joint head is not prestressed against the cup so that additional measures for support and guiding the mold mounting plate are required to prevent the mold from tilting. When the closing unit travels in closing direction, the absence of a prestress is secondary. However, execution of an exact compression stroke requires a precise positioning of the starting position of compression. Hereby, the moving mold mounting plate must be decelerated shortly before the compression starting position. As a consequence of the absence of a prestress in the cup bearing, the moving mold mounting plate, due to mass inertia, slips slightly forward by the gap provided for the tilting movement and formed between the ring flange and the joint head. As a result of the play, no exact compression stroke can be adjusted so that this device is hardly appropriate for injection-compression molding.

It would therefore be desirable and advantageous to provide an improved apparatus for compensation of an angle error in a closing unit of an injection molding machine which obviates prior art shortcomings and in which the same prestressing force is always applied even at an angular misalignment and which operates in a precise manner also over longer operating periods and in which the application of pressure compartments to be subjected across a large area is omitted.

### SUMMARY OF THE INVENTION

According to one aspect of the present invention, an apparatus for compensation of tilting in a closing unit of an injection molding machine, includes a moving mold mounting plate supporting a half-mold, a fixed mold mounting plate supporting a half-mold, a base plate securable to one of the mold mounting plates, a mold carrier plate for receiving the half-mold of the one mold mounting plate, with the mold carrier plate being tiltable in relation to the base plate, a cup bearing disposed between the base plate and the mold carrier plate, a prestressing means for loading the base plate relative to the mold carrier plate such that a gap is established between the base plate and the mold carrier plate outside the cup bearing, said prestressing means arranged at such a slant to a symmetry axis of the closing unit that contact surfaces of the mold carrier plate, which are acted upon by the prestressing means, and a bearing surface of the cup bearing lie substantially on calottes in parallel relationship.

The present invention resolves prior art problems by maintaining a substantially constant prestressing force even at tilting.

According to another feature of the present invention, the prestressing means for the mold carrier plate can be equipped with cup-like pressure-applying pieces which are placed in matching depressions, and both elements extend in accordance with another feature of the invention together with the bearing surface of the cup bearing upon the same radius.

Another feature of the present invention, there is provided an axially shiftable centering ring, which can be adjusted to a predetermined compression stroke. This configuration is suitable especially for injection-compression molding in which the plasticized plastic is injected in a cavity which is initially of greater size than the actual size of the molded part and is reduced through execution of a compression stroke to the actual size of the molded part.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal section through an apparatus according to the invention;

FIG. 2 is an enlarged illustration of the cutout X of FIG. 1;

FIG. 3 is a plan view upon the mold carrier plate as viewed in the direction of the arrow A in FIG. 1 (without mold carrier plate);

FIG. 4 is a plan view upon the moving side of the closing unit, when the closing unit is open, as viewed in the direction of the arrow B in FIG. 1;

FIG. 5 is a longitudinal section depicting the closing unit with angle error;

FIG. 6 is a longitudinal section depicting the closing unit with axis offset; and

FIG. 7 is a second embodiment of a prestressing means.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. The exemplified embodiment described in the following in more detail relates to the field of making high-quality plane-parallel injection molded articles, such as in particular substrates for CD, DVD and the like. The application of the invention is, however, not limited to this technical field. Rather, the apparatus according to the invention is applicable for the production of any molded parts and all types of injection molding machines, including injection molding machines with closing units guided along tie rods as well as rodless injection molding machines.

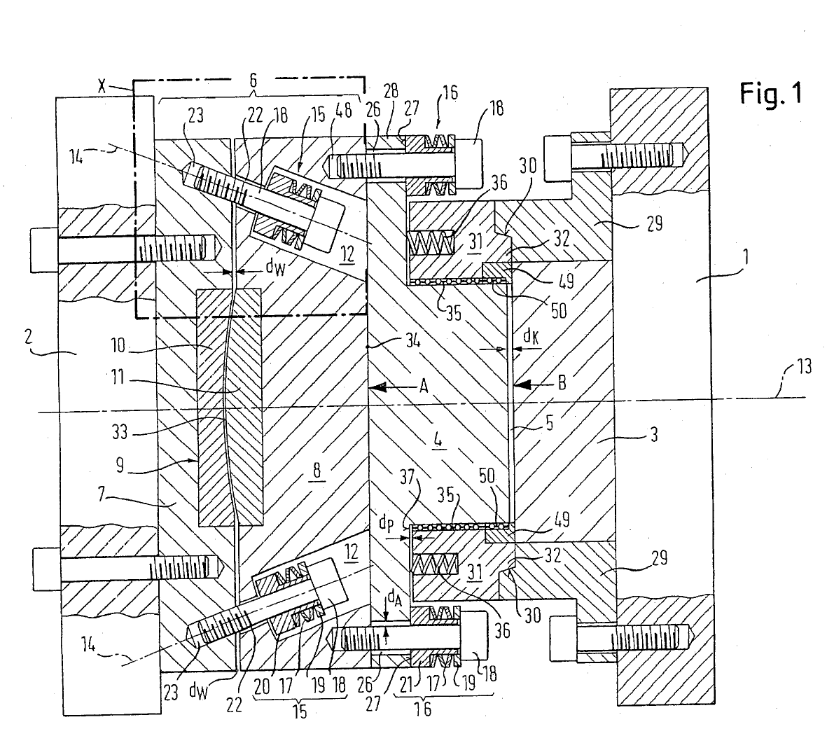

According to FIGS. 1 to 4, an injection molding machine with a typical closing unit includes a molding tool (3, 4) mounted between a fixed mold mounting plate 1 and a moving mold mounting plate 2. In closed state—as shown here—, the half-molds 3 and 4 define a plane-parallel cavity 5 with a gap measure d_{K} for molding substrates for optically readable data carriers. An angle compensating element 6 is disposed between the moving mold mounting plate 2 and the half-mold 4 associated thereto. The base plate 7 of this angle compensating element 6 is securely screwed to the moving mold mounting plate 2 and hingedly connected with the mold carrier plate 8 via a cup bearing 9, whereby the cup 10 of the cup bearing is formed in the base plate 7, and the ball 11 of the cup bearing is placed in the mold carrier plate 8 such that a gap d_{W} is defined between base plate and mold carrier plate for allowing a rotation of the base plate 7 relative to the mold carrier plate 8. The ball 11 and/or the cup 10 are provided with a suitable sliding layer. Several oblong holes 12 are provided in the mold carrier plate 8 in symmetry about and slantingly to the symmetry axis 13 of the closing unit, whereby all the longitudinal axes 14 of the oblong holes 12 intersect in a point upon the symmetry axis 13 of the closing unit. The oblong holes are provided for receiving the spring elements 15 by which the mold carrier plate 8 is mounted under pressure against the base plate 7. Each spring element 15 is made of a spring assembly 17 which is pressed against pressure-applying elements 20 by means of a screw 18 and a washer 19. The screws 18 extend through bores 22 in the mold carrier plate 8 and screwed into matching threaded bores 23 in the base plate 7. The diameter of the bores 22 is slightly greater than the outer diameter of the spring assemblies 17 so that the mold carrier plate 8 is slightly rotatable about the gap width d_{W} relative to the base plate 7 via the ball 11 in the cup 10.

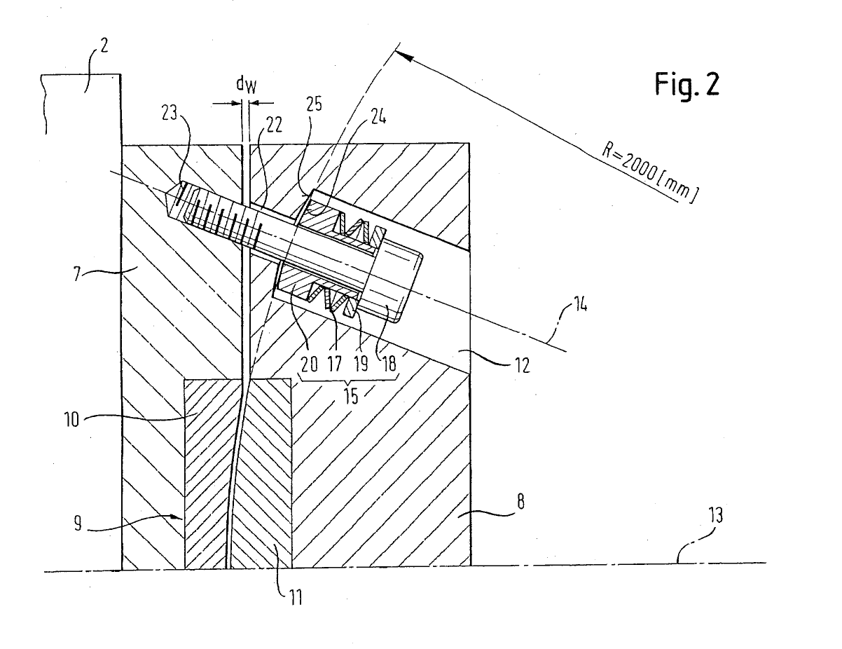

As shown by the enlarged illustration according to FIG. 2, the pressure-applying element 20 has one end which is distal to the spring assembly 17 and configured with a cup-shaped surface 24. The bottom of the oblong hole 12 has a matching cup-shaped depression 25 of a radius which is substantially the same as the radius of the cup-shaped surface 24 of the pressure-applying element 20. According to a further configuration of the invention, the radii of cup bearing 9, surface 24 and depression 25 are substantially of same size.

According to the invention, the cup-shaped pressure-applying elements 20 and the ball 11 of the cup bearing 9 extend substantially on calottes in parallel relationship, preferably on the same calotte. In this way, a uniform prestressing force is ensured, even when the mold carrier plate 8 pivots at an angular offset. In the present exemplified embodiment, the cup-shaped pressure-applying pieces 20, the depression 23 in the oblong hole 12, as well as the ball 11 and the cup 10 of the cup bearing 9 extend all on the same calotte at a radius of R=2000 mm.

In addition to the compensation of the angle error according to the invention, the compensation of an axis offset may be provided, whereby the half-mold 4 is constructed for movement relative to the mold carrier plate 8, for example in a form and manner described in the following. The half-mold 4 is secured on the mold mounting plate 8 via further spring elements 16 of the afore-described type which are distributed in symmetry about the half-mold 4; However, the individual components (spring assembly 17, screw 18, washer 19 and pressure-applying element 21) may be configured in a different manner; In particular the pressure-applying element 21 has a planar contact surface 27. The half-mold 4 has an outer zone 28 provided with bores 26 in symmetry about the circumference for receiving the screws 18 which are screwed into matching threaded bores in the mold carrier plate 8. The diameter of the bores 26 is greater by a gap measure 2d_{A} than the diameter of the screws 18 so that the half-mold 4 can move relative to the mold carrier plate 8 for compensation of an axis offset between the half-molds 4 and 3. The partition plane 34 between the mold carrier plate 8 and the half-mold 4 is provided with a suitable sliding layer so that the need for additional separate sliding means is eliminated while still ensuring an easy movement between the mold carrier plate 8 and the half-mold 4 mounted under pressure thereon.

It may further be provided to combine the apparatus for angle compensation in accordance with the invention with a device which enables an automatic re-centering when an angle error and possibly an axis offset is encountered. Hereby, there is mounted to the half-mold 3 is further a first centering ring 29 having a cone-shaped depression 30 for receiving a complementary centering cone 32 of a second centering ring 31 mounted to the moving half-mold 4. This ensures an automatic compensation of an angle error (and optionally an axis offset). When the moving and fixed mold mounting plates are non-parallel, the mold (3, 4) is automatically aligned in the partition plane 33 by the interaction of centering cone 32 and cone-shaped depression 30, with the ball 11 in the cup 10 rotating into an exact position in which the centering cone 32 is seated precisely in the depression 30. The gap measure d_{K} of the cavity 5 remains thus always the same. The prestress of the spring assemblies 17 upon the pressure-applying elements 20 and 21 maintains the mold 3, 4 in the aligned position as long as the closing unit does not undergo a change. In the event the state of the closing unit changes during production, e.g. through wear, an angular offset causes the centering rings 29 and 31 to automatically re-align the mold carrier plate 8. Likewise, a possibly encountered new axis offset can again be compensated by means of the interlocking centering rings 29 and 31 through automatic displacement of the half-mold 4 relative to the mold carrier plate 8. The prestress of the spring assemblies 17 should be so adjusted that the mold opening forces are smaller than the prestressing force and that the centering cone 32 is capable to move the mold (3, 4) in the partition planes 33 and 34 without wear.

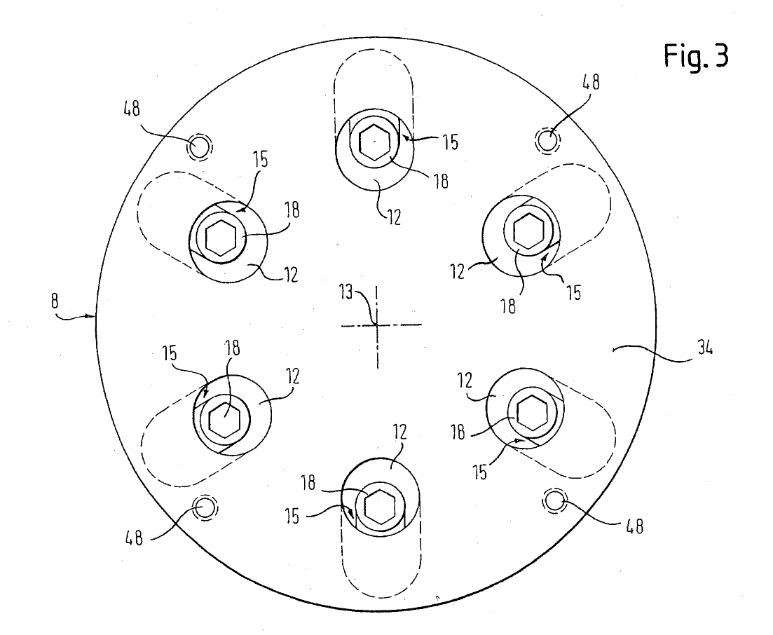

FIG. 3 shows a section in the partition plane 34 and clearly depicts the arrangement of the prestressing means in accordance with the invention, by which the mold carrier plate 8 is mounted under pressure against the base plate 7. The present exemplified embodiment includes six spring elements 15 in symmetric disposition about the symmetry axis 13 of the closing unit. The oblong holes 12 extend outwards slantingly to the symmetry axis 13 and terminate in the interior of the mold carrier plate 8. Furthermore, there are provided four threaded bores 48 in which the screws 18 of the second spring element 16 for prestressing the half-mold 4 can be screwed in.

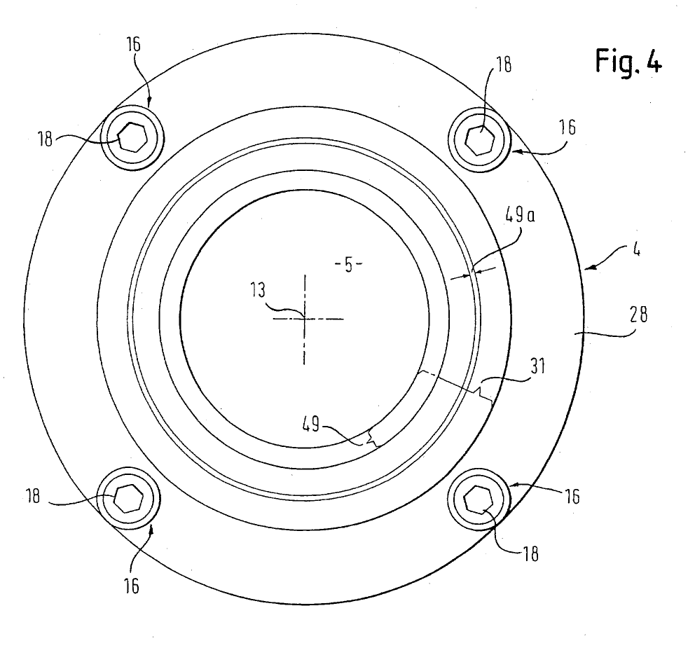

FIG. 4 shows a section through the mold partition plane and clearly illustrates the arrangement of the prestressing means of the second type, by which the moving half-mold 4 is mounted under pressure against the mold carrier plate 8. The present exemplified embodiment includes four spring elements 16 in symmetric disposition about the symmetry axis 13 of the closing unit. The pressure-applying elements 21 with a planar contact surface 27 are pressed by means of spring assemblies 17 against the outer zone 28 of the half-mold 4. In order to adjust the spring force, the screws 18 extend through the bores 26 to the marginal zone 28 of the half-mold 4 and are screwed into matching threaded bores in the outer zone of the mold carrier plate 8. A form ring 49 is seated on the centering ring 32 with the centering cone 32, whose projected surface 49a is depicted in FIG. 4, in the area of the cavity 5 upon a ball cage 50.

The prestressing means differ in the construction of the pressure-applying pieces (cup-shaped pressure-applying piece 20 versus planar pressure-applying piece 21). However, also the remaining components may be dimensioned individually and suited to the respective needs, in particular spring assemblies with different spring constants may be used.

According to a further configuration of the invention, an injection-compression molding process with an exactly reproducible compression stroke should be carried out. Hereby, the centering ring 31 is supported play-free in the half-mold 3 for axial displacement by means of a prestressed ball cage 35. The ball cage 35 transmits the necessary transverse forces for mold alignment. The compression stroke d_{P} is mechanically firmly adjusted via the mold (3, 4) by means of spacers, for example by means of sleeves of appropriate length, and the centering ring 31 is restrained in the position, established by the spacers, namely at the distance dₚ from the stop surface 37. When the half-molds approach one another sufficiently enough for the centering cone 32 to descend into the depression 30 of the centering ring 29, the half-molds 3 and 4 are aligned at first. Hereby, the spring force of the spring assemblies 36 must be greater than the force required for displacement of the moving half-mold 4. Immediately before execution of the compression stroke d_{P}, the half-molds 3 and 4 are in alignment, i.e. the half-molds are disposed in absolutely plane-parallel relationship and the symmetry axes of the half-molds 3 and 4 are absolutely in congruence. Subsequently, the closing unit travels in closing direction about the distance d_{P} and the spring assemblies 36 are compressed until the centering ring bears upon the stop surface 37. The cavity 5 is thus absolutely parallel during commencement of compression and during the entire compression process, so that the mold part satisfies highest demands with respect to plane-parallelism. The gap measure d_{K} of the cavity at beginning of the compression stroke corresponds to the sum of mold part thickness d_{F} and compression stroke d_{P}.

The provision of suitable sliding layers between the prestressed parts, which move relative to one another, ensures an easy movement of these parts into the aligned position, when the centering cone 32 descends into the cone-shaped depression 30 of the centering ring 29. Therefore, the ball 11 and/or the cup 10 of the cup bearing are equipped with a sliding layer. A sliding layer is also provided between the mold carrier plate 8 and the half-mold 4. Optionally, also the pressure-applying pieces 20, 21 of the prestressing means may be provided with a sliding layer.

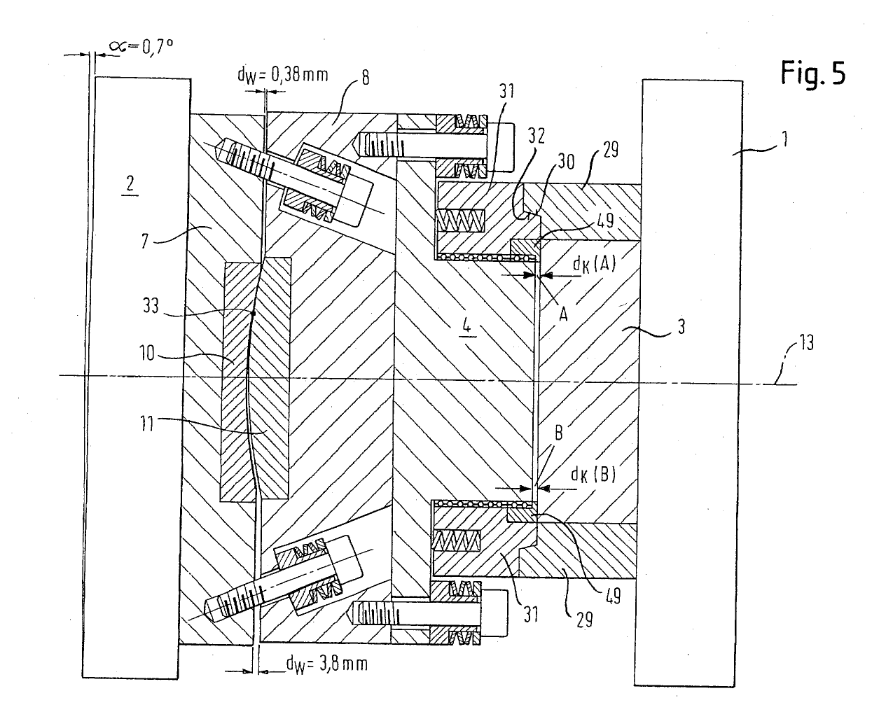

FIG. 5 shows the closing unit with an angle error, but without axis offset. The moving mold mounting plate 2 is tilted about a small angle α with respect to the vertical disposition. As a consequence, also the base plate 7, screwed onto the mold mounting plate 2, is also correspondingly tilted. As a consequence of the closing process and the descent of the centering cone 32 into the cone-shaped depression 30, the ball 11 included in the mold mounting plate 8 is rotated in the cup 10 such that the half-molds 3 and 4 are in precise plane-parallel disposition. The mold carrier plate 8 and the attached half-mold 4 have thus been aligned through rotation in the partition plane 33. The gap measure d_{W} is hereby decreased to 0.38 mm on the one side and increased to 3.8 mm on the other side. The cavity measure d_{K} remained the same over the entire width of the cavity, i.e. the thickness of the cavity d_{K}(A) at the position A is of same size as the thickness of the cavity d_{K}(B) at the position B.

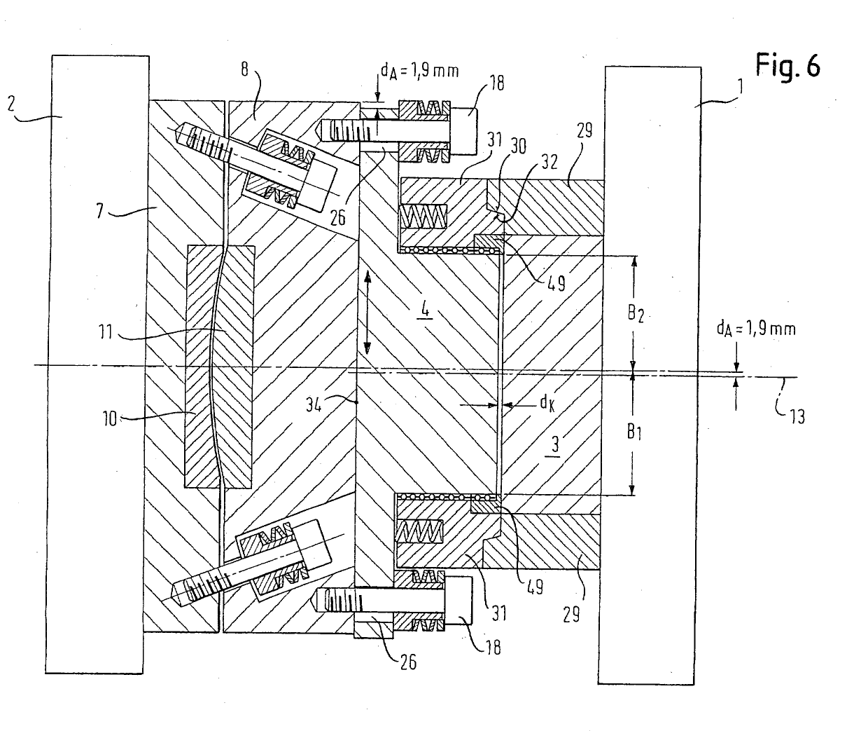

FIG. 6 shows the closing unit with axis offset, but without angle error. The moving mold mounting plate 2 is offset at the beginning of the closing movement by, for example, 1.9 mm with respect to the symmetry axis 13. During closing, the centering cone 32 descends into the cone-shaped depression 30 and shifts the half-mold 4 along the partition plane 34 with respect to the mold carrier plate 8 by this amount. The screws 18 then do no longer seat centrally in the bores 26, as shown in FIG. 1, but extend almost at the upper edge of the bores 26. Thus, the cavity remains the same (B₁=B₂) and no misalignment is experienced between the half-molds 3 and 4.

Should an angle error as well as an axis offset occur, the descent of the centering cone 32 into the cone-shaped depression 30 is accompanied in the partition plane 33 by a rotation movement and at the same time a parallel displacement in the partition plane 34.

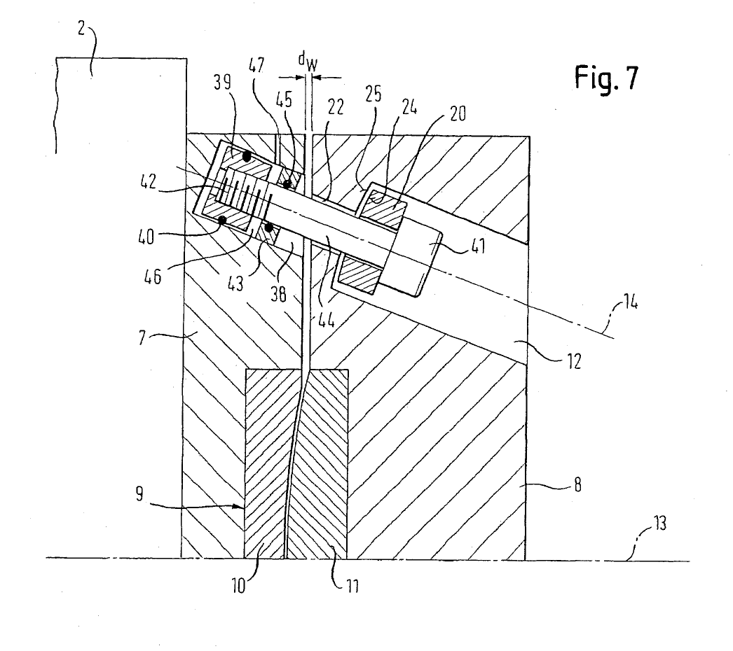

FIG. 7 shows an alternative embodiment of the prestressing means with a small hydraulically or pneumatically actuatable piston-cylinder units. The base plate 7 includes an oblong hole 38 in coaxial relationship to the oblong hole 12 in the mold carrier plate 8. The pressure-applying element 20 is forced in the oblong hole 12 by a bolt 41 against the contact surface 25. The shank 44 of the bolt 41 extends through the bore 22, projects into the oblong hole 38 in the base plate 7 and is movably supported in a ring 43, which closes the oblong hole 38, in a fluid-tight manner by means of one or more suitable sealing rings 45. Screwed onto the end portion 42 of the bolt 41 is a piston 39 which closely rests upon the inner wall of the oblong hole 38 by means of one or more sealing rings 40 and reciprocates therein. The space 46 between the piston 39 and the ring 43 can be acted upon by a pressure medium from a line 47. Through setting of a suitable pressure in the space 46, the bolt 41 is forced together with the pressure-applying element 20 at the necessary prestress against the contact surface 25.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. Apparatus for compensation of tilting in a closing unit of an injection molding machine, comprising:
a moving mold mounting plate supporting a half-mold;
a fixed mold mounting plate supporting a half-mold;
a base plate securable to one of the mold mounting plates;
a mold carrier plate for receiving the half-mold of the one mold mounting plate, with the mold carrier plate being tiltable in relation to the base plate;
a cup bearing disposed between the base plate and the mold carrier plate;
a prestressing means for loading the base plate relative to the mold carrier plate such that a gap is established between the base plate and the mold carrier plate outside the cup bearing, said prestressing means arranged at such a slant to a symmetry axis of the closing unit that contact surfaces of the mold carrier plate, which are acted upon by the prestressing means, and a bearing surface of the cup bearing lie substantially on calottes in parallel relationship.

2. The apparatus of claim 1, wherein the contact surfaces and the bearing surface lie on a same calotte.

3. The apparatus of claim 1, wherein the prestressing means includes a plurality of prestressing units, each provided with a cup-like pressure-applying element.

4. The apparatus of claim 3 wherein the mold carrier plate includes a plurality of cup-like depressions for forming the contact surfaces for the pressure-applying elements, whereby the depressions and the pressure-applying elements are placed into one-to-one correspondence.

5. The apparatus of claim 4, wherein the cup bearing has a ball in one member selected from the group consisting of base plate and mold carrier plate, and a cup in the other member of the group, wherein at least one member selected from the group consisting of pressure-applying elements and depressions has a radius which is substantially identical to a radius of one of the ball and the cup of the cup bearing.

6. The apparatus of claim 3, wherein the mold carrier plate has a plurality of oblong holes for receiving the prestressing units of the prestressing means, whereby the oblong holes and the prestressing units are placed into one-to-one correspondence.

7. The apparatus of claim 1, wherein the cup bearing has a ball in one member selected from the group consisting of base plate and mold carrier plate, and a cup in the other member of the group, wherein at least one of the ball and the cup are provided with a sliding layer.

8. The apparatus of claim 4, wherein at least one member selected from the group consisting of the cup-like pressure-applying pieces and the cup-like depressions is provided with a sliding layer.

9. The apparatus of claim 1, wherein the prestressing means includes a spring element, and a restraining member for securing the spring element in the base plate, wherein the restraining member extends through a bore in the mold carrier plate and is secured in the base plate, wherein the bore has a diameter which is slightly greater than a diameter of the restraining member.

10. The apparatus of claim 9, wherein the spring element is a member selected from the group consisting of disk spring, flat coil, and rubber spring.

11. The apparatus of claim 9, wherein the restraining member is a screw.

12. The apparatus of claim 1, and further comprising a first centering ring disposed on one of the half-molds and having a cone-like depression, and a second centering ring disposed on the other one of the half-molds and having a centering cone of a configuration complementing the depression.

13. The apparatus of claim 12, wherein one of the first and second centering rings is constructed for movement in axial direction.

14. The apparatus of claim 13, and further comprising a ball cage, wherein the one of the first and second centering rings is mounted on the half-mold for movement in axial direction via the ball cage, which is placed on said half-mold.

15. The apparatus of claim 13, wherein the one of the first and second centering rings is resiliently supported in axial direction.
